(19) United States
(12) Patent Application Publication
(10) Pub. No.: US 2023/0097744 A1
(43) Pub. Date: Mar. 30, 2023

(54) COMMUNICATION SYSTEM AND COMMUNICATION TERMINAL

(71) Applicant: Yazaki Corporation, Tokyo (JP)

(72) Inventors: Genki HOSOKAWA, Kanagawa (JP); Tadahide KUNITACHI, Kanagawa (JP)

(73) Assignee: Yazaki Corporation, Tokyo (JP)

(21) Appl. No.: 17/953,019

(22) Filed: Sep. 26, 2022

(30) Foreign Application Priority Data
Sep. 27, 2021 (JP) 2021-156288

(51) Int. Cl. H04W 28/08; H04W 40/02; H04W 40/24

(52) U.S. Cl. CPC H04W 28/0892; H04W 40/02; H04W 40/248

(57) ABSTRACT

Provided is a communication system including multiple communication terminals, which are layered in a first layer, a second layer, and a third layer. The communication system includes at least two first communication terminals provided in the first layer. The communication system includes multiple second communication terminals provided in the second layer and capable of directly communicating with the first communication terminals. The communication system includes multiple third communication terminals provided in the third layer and capable of directly communicating with some of the second communication terminals. The second communication terminals and the third communication terminals are provided in multiple separate areas. A third communication terminal from among the third communication terminals performs communication via one of the first communication terminals when communicating with one of the second communication terminals or one of the third communication terminals in an area different from an area where the third communication terminal is provided.

### CROSS-REFERENCE TO RELATED APPLICATIONS

The present application is based on, and claims priority from Japanese Patent Application No. 2021-156288, filed on Sep. 27, 2021, the entire contents of which are incorporated herein by reference.

### TECHNICAL FIELD

The present disclosure relates to a communication system and a communication terminal.

### BACKGROUND

A technique has been proposed for performing communication between terminals using an optimum route in a communication system constituted by multiple terminals (nodes). JP 2012-217112 A discloses a communication network using a tree topology. The communication network disclosed in JP 2012-217112 A uses an adjacent node as a backup node to maintain reliability of routes constituting the network.

### SUMMARY

In the communication network disclosed in JP 2012-217112 A, a root node in the highest layer is constituted by one node, and thus a communication bottleneck may occur at this root node. Since an adjacent node is used as a backup node, when a failure occurs in a certain node, communication traffic may be concentrated in a route near the node where the failure occurred.

An object of the disclosure is to provide a communication system capable of suppressing an increase in communication traffic between communication terminals.

A communication system of the present disclosure includes multiple communication terminals capable of communicating with each other and layered in a first layer, a second layer, and a third layer, the communication system including at least two first communication terminals that are communication terminals provided in the first layer, multiple second communication terminals that are communication terminals provided in the second layer and are capable of directly communicating with the first communication terminals, and multiple third communication terminals that are communication terminals provided in the third layer and are capable of directly communicating with some of the second communication terminals, wherein the second communication terminals and the third communication terminals are provided in multiple separate areas, and a third communication terminal from among the third communication terminals performs communication via one of the first communication terminals when communicating with one of the second communication terminals or one of the third communication terminals in an area different from an area where the third communication terminal is provided.

A communication terminal of the present disclosure is a communication terminal provided in the above-described communication system, including a terminal information acquisition unit that acquires terminal information including connection information on a connection with a communication terminal included in an upper layer or a lower layer, a data transmission determination unit that determines a transmission destination of transmission data in a communication path to a destination terminal, based on the terminal information, and a transmission unit that transmits the transmission data to another communication terminal of the upper layer or the lower layer based on a determined result.

### BRIEF DESCRIPTION OF THE DRAWINGS

FIG. 1 is a diagram illustrating a network configuration example of a communication system according to a present embodiment.

FIG. 2 is a block diagram illustrating a configuration of a communication terminal according to the present embodiment.

FIG. 3 is a block diagram illustrating a functional configuration of the communication terminal according to the present embodiment.

FIG. 4 is a diagram illustrating communication strength between terminals at the communication terminal according to the present embodiment.

FIG. 5 is a diagram illustrating terminal information according to the present embodiment.

FIG. 6 is a flowchart illustrating an example of processing in the communication terminal according to the present embodiment.

FIG. 7 is a flowchart illustrating an example of data transmission processing according to the present embodiment.

### DETAILED DESCRIPTION

Various embodiments will be described hereinafter with reference to the accompanying drawings.

A detailed description is given below of a communication system 10 according to the present embodiment with reference to the drawings. Note that dimensional ratios in the drawings are exaggerated for convenience of explanation and are sometimes different from actual ratios. In the following drawings, the same or similar parts are denoted by the same or similar symbols.

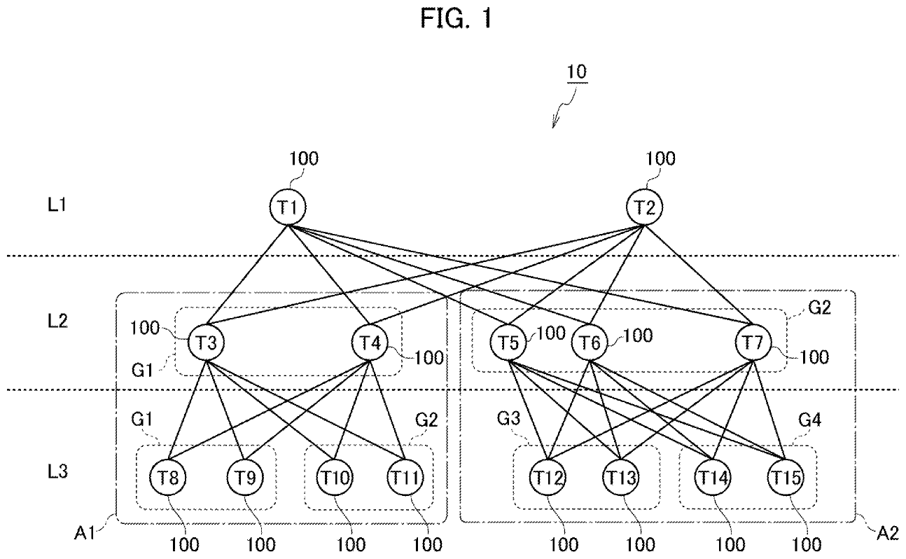

FIG. 1 illustrates a configuration example of the communication system 10 according to the present embodiment. As illustrated in FIG. 1, the communication system 10 includes multiple communication terminals 100 capable of communicating with each other, and the multiple communication terminals 100 are layered in a first layer L1, a second layer L2, and a third layer L3. Note that in the communication system 10 according to the present embodiment, it is assumed that the first layer L1 is the highest layer and there is no layer higher than the first layer L1. The communication system 10 is hierarchically configured in order from the first layer L1 downward to the second layer L2 and the third layer L3. Note that the communication system 10 according to the present embodiment may include a layer lower than the third layer L3. This specification describes a case of a configuration with three layers of the first layer L1, the second layer L2, and the third layer L3.

In the example in FIG. 1, communication terminals T1 to T15 are illustrated as multiple communication terminals 100. When it is not necessary to separately describe each of the communication terminals T1 to T15, simply the “communication terminal 100” is used below.

In the example in FIG. 1, the first layer L1 includes at least two communication terminals T1 and T2. The communication terminals T1 and T2 provided in the first layer L1 correspond to first communication terminals.

The second layer L2 includes multiple communication terminals 100 capable of directly communicating with both of the communication terminals T1 and T2. Specifically, in the example in FIG. 1, communication terminals T3 to T7 capable of directly communicating with the communication terminals T1 and T2 are illustrated in the second layer L2. Note that the communication terminals T3 to T7 in the second layer L2 correspond to second communication terminals.

The third layer L3 includes multiple communication terminals 100 capable of directly communicating with some of the communication terminals T3 to T7 in the second layer L2. In the example in FIG. 1, communication terminals T8 to T11 capable of directly communicating with communication terminals T3 and T4 are illustrated in the third layer L3. That is, the communication terminals T8 to T11 are not capable of communicating with all the communication terminals 100 in the second layer L2 and are capable of directly communicating with the communication terminals T3 and T4, which are some of the communication terminals 100 in the second layer L2.

In a similar manner, in the example in FIG. 1, communication terminals T12 to T15 capable of directly communicating with communication terminals T5 to T7 are illustrated in the third layer L3. That is, the communication terminals T12 to T15 are not capable of communicating with all the communication terminals 100 in the second layer L2 and are capable of directly communicating with the communication terminals T5 to T7, which are some of the communication terminals 100 in the second layer L2. The communication terminals T8 to T15 in the third layer L3 correspond to third communication terminals.

As illustrated in FIG. 1, there are a first area A1 and a second area A2 in the communication system 10, and the communication terminals T3 to T15 are separately included in either area. In the example in FIG. 1, the communication terminals T3 and T4 in the second layer L2 and the communication terminals T8 to T11 in the third layer L3 are included in the first area Al. In the example in FIG. 1, the communication terminals T5 to T7 in the second layer L2 and the communication terminals T12 to T15 in the third layer L3 are included in the second area A2.

The communication terminals 100 may be provided in separate groups as illustrated in FIG. 1. In the example in FIG. 1, a group G1 and a group G2 are provided in the second layer L2. In the example in FIG. 1, groups G1 to G4 are provided in the third layer L3. The communication terminals 100 in the second layer L2 and the third layer L3 are grouped and included in this way, and thus it is possible to roughly classify communication paths, for example, in communication with a communication terminal 100 as the destination of communication.

In the example in FIG. 1, the communication system 10 includes multiple communication terminals 100 in the first layer L1, which is the highest layer. In the communication system 10, communication terminals 100 in the second layer L2 and the third layer L3 are provided in separate areas. Thus, when a communication terminal 100 in the third layer L3 communicates with a communication terminal 100 in an area different from the area where the communication terminal 100 in the third layer L3 is provided, it communicates via a communication terminal 100 in the first layer L1. This configuration in which multiple communication terminals 100 are provided in the highest first layer L1 enables the communication system 10 to prevent the communication bottleneck in the highest layer. The communication terminals 100 included in the second layer L2 and the third layer L3 are provided in separate areas. Thus, for example, it is possible to prevent the concentration of communication to a specific communication terminal 100 of the second layer L2 or the third layer L3 and to prevent an increase in communication traffic.

### (Configuration of Communication Terminal 100)

Next, the configuration of the communication terminal 100 is described.

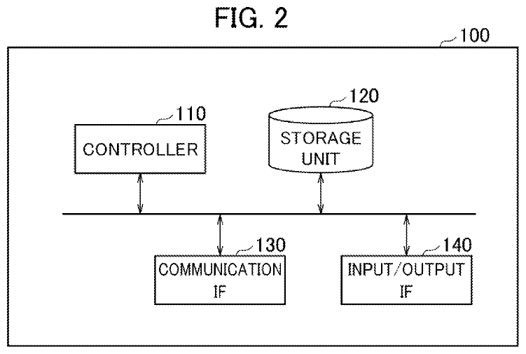

FIG. 2 is a block diagram illustrating a configuration of the communication terminal 100 according to the present embodiment. For example, as illustrated in FIG. 2, the communication terminal 100 may be configured as a general-purpose computer (microcomputer) including a controller 110, a storage unit 120, a communication IF 130, and an input/output IF 140. Here, a computer program for making the computer function as the communication terminal 100 may be installed in the computer. By executing a computer program, the computer functions as multiple information processing circuits provided in the communication terminal 100. Note that although the present embodiment explains an example in which multiple information processing circuits provided in the communication terminal 100 are implemented by software, it is of course possible to constitute the information processing circuits by providing dedicated hardware for executing the following information processing. Multiple information processing circuits may be constituted by individual hardware. Details of the controller 110 are described later.

The storage unit 120 may be a ROM (read-only memory), a RAM (random-access memory), a hard disk, or the like. The storage unit 120 can also store various data such as input data, output data, and intermediate data for the communication terminal 100 to execute processing.

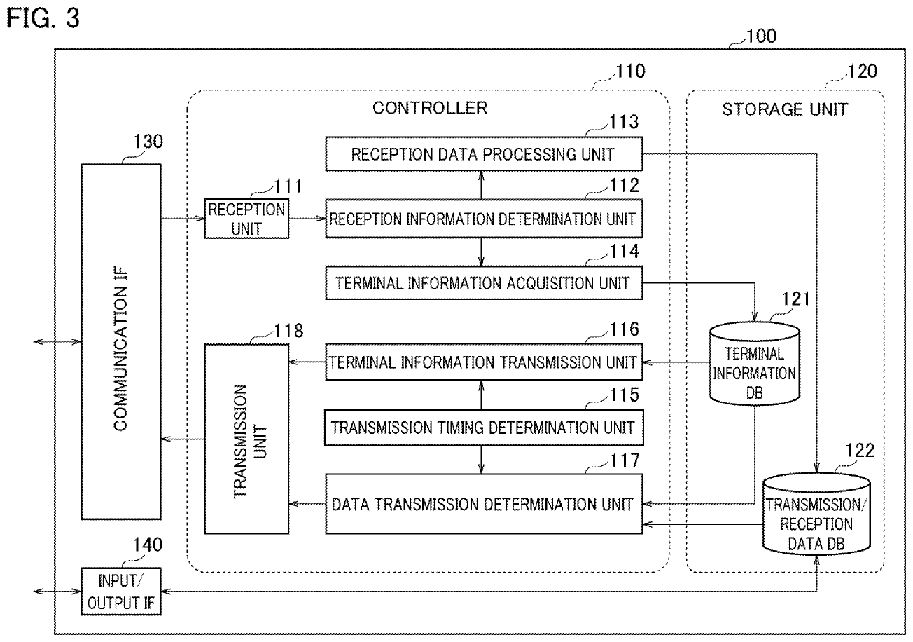

As illustrated in FIG. 3, the storage unit 120 stores information contained in a terminal information DB121 (DB: data buffer) and a transmission/reception data DB 122 as data. Note that there may be one or multiple storage units 120 for storing the above-described data. For example, single storage unit 120 may be configured to store data in separate sections. Alternatively, data may be distributed and stored in multiple storage units installed at physically remote locations.

The communication IF 130 is an interface for enabling communication with other communication terminals 100. In the present embodiment, wireless communication is applied to communication with other communication terminals 100. Note that the communication with other communication terminals 100 is not limited to wireless communication, and wired communication may be applied.

The input/output IF 140 is a component (interface) for a user to exchange data with the communication terminal 100, for example. For example, the input/output IF 140 includes an input unit and an output unit, which are not illustrated.

The input unit of the input/output IF 140 has an interface function for inputting various information by a user, and information may be input from the outside of the communication terminal 100. Information may be input to the input unit by a user through a keyboard, a mouse, a touch panel, a trackball, a voice recognition device, or the like connected to the communication terminal 100. The input unit can input information as a data input terminal for inputting data from an external storage device, which is not illustrated, or the like. For example, the user can store, through the input/output IF 140, transmission data stored in the above-described transmission/reception data DB 122 and starting from this communication terminal 100.

The output unit of the input/output IF 140 can display, for example, a communication state or a processing result of reception data on a display device such as a display, which is not illustrated, connected to the communication terminal 100.

FIG. 3 is a block diagram illustrating a functional configuration of the communication terminal 100. As illustrated in FIG. 3, the controller 110 includes a reception unit 111, a reception information determination unit 112, a reception data processing unit 113, and a terminal information acquisition unit 114 as functions of the reception end. The controller 110 includes a transmission timing determination unit 115, a terminal information transmission unit 116, a data transmission determination unit 117, and a transmission unit 118 as functions of the transmission end.

The reception unit 111 receives terminal information transmitted from other communication terminals 100 or transmission data transmitted from other communication terminals 100, as reception data. In the present embodiment, the transmission data and the reception data are data that are communication targets in communication between the communication terminals 100.

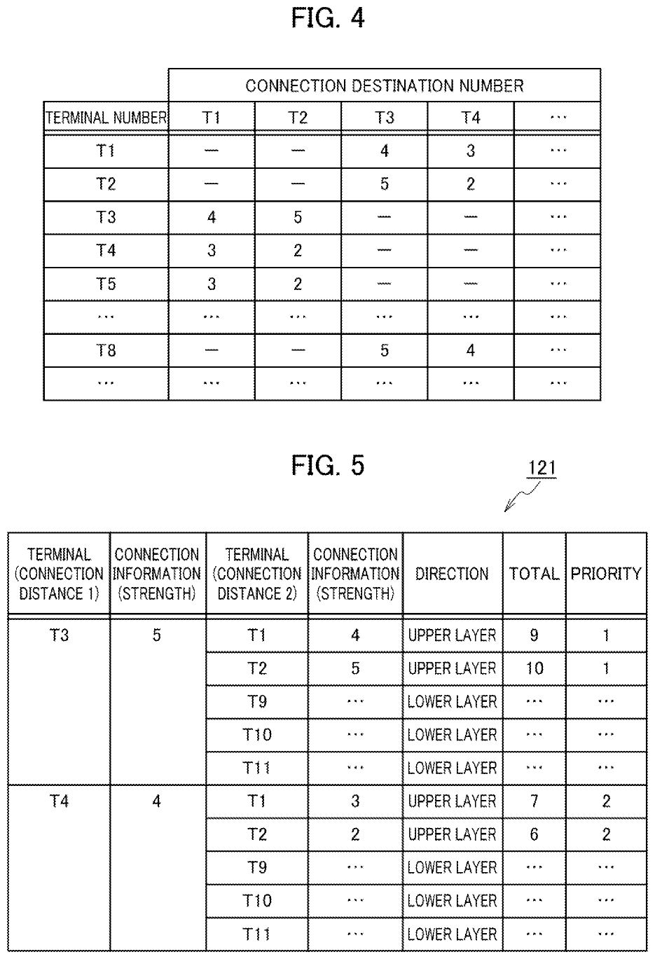

In the present embodiment, the terminal information is connection information on connections with other communicable communication terminals 100. For example, the connection information is communication strength with other communication terminals 100. Specifically, the communication strength is an RSSI (Received signal strength indicator), which is a measurement value of power present in the reception data. FIG. 4 is an example of reception strength of communication terminals 100 of the communication system 10 in FIG. 1, which are simply expressed by numerals. In the example in FIG. 4, for example, the communication terminal T8 whose terminal number is “T8” has communication strength “5” with the communication terminal T3 and communication strength “4” with the communication terminal T4. In this case, it is indicated with the size of numbers that the communication strength between the communication terminals T8 and T3 is higher than the communication strength between the communication terminals T8 and T4.

The reception information determination unit 112 determines whether the data received by the reception unit 111 is terminal information or transmission data. The reception information determination unit 112 determines the data based on identification information provided in a header, which is not illustrated, of each of the terminal information and the transmission data. When determining that the data received by the reception unit 111 is transmission data, the reception information determination unit 112 sends the transmission data transmitted from another terminal to the reception data processing unit 113 as reception data. When determining that the data received by the reception unit 111 is terminal information, the reception information determination unit 112 sends the terminal information to the terminal information acquisition unit 114.

When the reception data is transmission data from another terminal, the reception data processing part 113 performs predetermined processing on the transmission data. Specifically, the reception data processing unit 113 determines whether the reception data is data addressed to the terminal thereof (hereinafter referred to as “host terminal”) or data addressed to another terminal. The determination as to whether the reception data is data addressed to the host terminal or data addressed to another terminal is performed, for example, based on information relating to a destination of data stored in the header of the reception data.

When determining that the reception data are data addressed to the host terminal, the reception data processing unit 113 stores the reception data in the transmission/reception data DB 122. The reception data stored in the transmission/reception data DB 122 is subjected to predetermined processing by the communication terminal 100 according to the contents of the reception data. The user may also acquire the reception data addressed to the host terminal stored in the transmission/reception data DB 122 via the input/output IF 140.

When determining that the reception data is data addressed to another terminal, the reception data processing unit 113 stores the reception data in the transmission/reception data DB 122 as data for transmission. In the present embodiment, the data for transmission is data stored in the transmission/reception data DB 122 of the host terminal and is data before transmission to another terminal. The data for transmission stored in the transmission/reception data DB 122 is transmitted as transmission data to another communication terminal 100 via the data transmission determination unit 117 and the transmission unit 118 described later. Details of the data for transmission and the transmission processing of the transmission data are described later.

When the reception data is terminal information, the terminal information acquisition unit 114 updates the terminal information stored in the terminal information DB 121.

FIG. 5 includes information corresponding to the reception strength in FIG. 4 and illustrates an example of the terminal information stored in the communication terminal T8. Here, terminals of “connection distance 1” in FIG. 5 are communication terminals 100 capable of directly communicating with the communication terminal T8. Terminals of “connection distance 2” in FIG. 5 are communication terminal 100 with which the terminals of “connection distance 1” are capable of directly communicating. For example, in the case of the communication terminal T8 of the communication system 10 in FIG. 1, the terminals of “connection distance 1” are the communication terminals T3 and T4. The terminals of “connection distance 2” are the communication terminals T1, T2, T9, T10, and T11 capable of directly communicating with the communication terminals T3 and T4.

In the present embodiment, the terminal information includes both the communication strength between this communication terminal 100 and communication terminals 100 having the “connection distance 1” and capable of direct communication with this communication terminal 100, and the communication strength between the communication terminals 100 having the “connection distance 1” and communication terminals 100 having the “connection distance 2”.

The terminal information stored in the terminal information DB 121 includes the total value of the communication strength and priority, which are the connection information. In the present embodiment, the higher the total value of the communication strength, the higher the priority. The example in FIG. 5 illustrates a case in which the total value of the communication strength in a path through the communication terminals T3 and T2 is the highest. In this case, the communication terminal T8 has the highest priority for the communication terminal T3 and has the second priority for the communication terminal T4.

As described above, in the present embodiment, the communication strength for all the paths in FIG. 4, for example, is not stored as the terminal information. That is, the terminal information includes only the communication strength with communication terminals 100 having the connection distance 1 and connectable to the communication terminal 100 that is the host terminal, and the communication strength with communication terminals 100 connectable to the communication terminals having the connection distance 1. That is, the terminal information includes connection information on connections with communication terminals 100 included in the upper layer or the lower layer. The terminal information also includes connection information regarding communication between one communication terminal 100 of the upper layer or the lower layer and another communication terminal 100 connected to the one communication terminal 100 of the upper layer or the lower layer. This makes it possible to suppress communication of extra terminal information and to suppress an increase in communication traffic between communication terminals by determining a route and performing communication based only on necessary connection information rather than all the connection information in the communication system 10.

The transmission timing determination unit 115 determines whether or not the timing for transmitting transmission data or terminal information has been reached.

When the transmission timing determination unit 115 determines that the timing for transmitting the terminal information has been reached, the terminal information transmission unit 116 transmits the terminal information. The terminal information transmitted from the communication terminal 100 is terminal information for terminals of the upper layer and terminals of the lower layer capable of communication with this communication terminal 100. The terminal information transmission unit 116 transmits the terminal information to the upper layer and/or the lower layer at a predetermined interval. Here, the predetermined interval at which the terminal information is transmitted depends on the communication system 10 to which the interval is applied. For example, the predetermined interval at which the terminal information is transmitted may be several milliseconds to several seconds.

The data transmission determination unit 117 determines a terminal to which transmission data is transmitted, based on the priority stored in the terminal information DB 121, and determines whether to transmit the transmission data stored in the transmission/reception data DB 122 to the communication terminal 100 that is a transmission target. That is, the data transmission determination unit 117 determines a transmission destination of the transmission data in a communication path to the destination terminal based on the terminal information. Note that in the present embodiment, the destination terminal is a communication terminal 100 that is the final destination of the transmission data in the network of the communication system 10. When a communication terminal 100 serving as the transmission target is not a destination terminal, based on the priority stored in the terminal information DB 121, the data transmission determination unit 117 determines a communication terminal 100 to which the transmission data is transmitted in order of priority. That is, the data transmission determination unit 117 determines to transmit the transmission data to the communication terminal 100 of the next priority after transmitting the transmission data to the communication terminal 100 of a high priority and receiving a response signal such as ACK or NACK. In the case of transmission data for an upper layer or a lower layer, transmission is performed to all the target communication terminals 100. In the example in FIG. 5, transmission data is transmitted from the communication terminal T8 to the communication terminal T3, and then transmission data is transmitted from the communication terminal T8 to the communication terminal T4.

In contrast, when the communication terminal 100 as the transmission target is the destination terminal, the data transmission determination unit 117 transmits the transmission data only to the destination terminal as the transmission target. For example, in the example in FIG. 1, when the host terminal is the communication terminal T8 and the destination terminal is the communication terminal T3, the communication terminal T8 transmits transmission data only to the communication terminal T3, and the transmission data is not transmitted to the communication terminal T4.

The transmission unit 118 transmits the terminal information or transmission data to the corresponding communication terminal 100 via the communication IF 130 based on the transmission processing from the terminal information transmission unit 116 and/or the result determined by the data transmission determination unit 117.

### (Outline of Processing Flow of Communication Terminal 100)

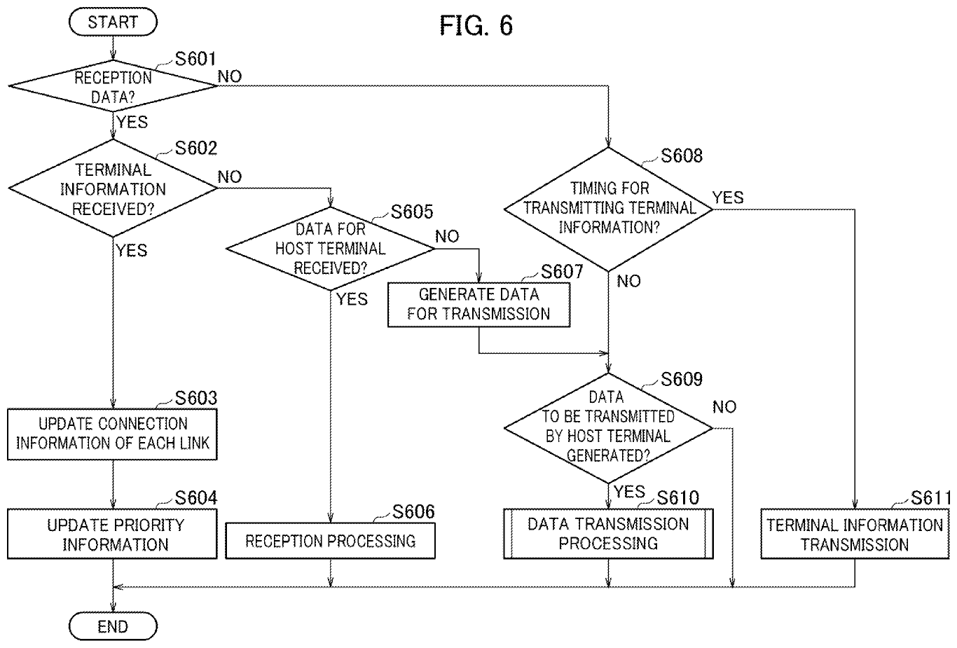

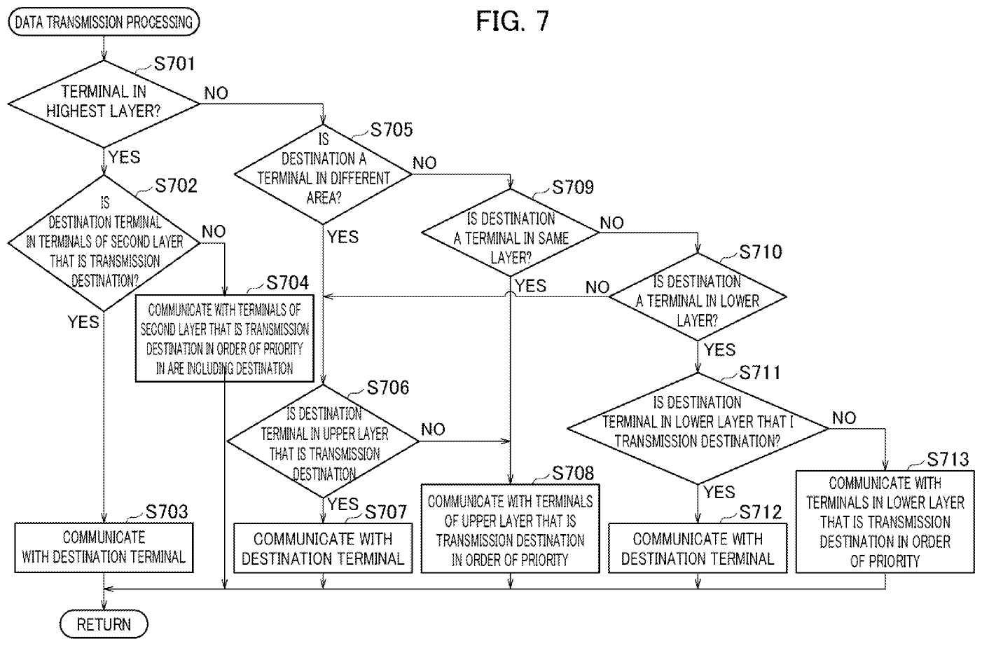

Next, the flow of processing in the communication terminal 100 is described with reference to the flowcharts in FIGS. 6 and 7. The series of operations of the communication terminal 100 in the flowcharts of FIG. 6 and FIG. 7 starts when the communication terminal 100 is started, and the processing ends with the end of processing. In the flowcharts of FIGS. 6 and 7, the processing is also terminated by power-off or interruption of processing termination. In the following description of the flowcharts, the same contents as those described in the above description of the communication system 10 and the communication terminal 100 are omitted or simplified.

The flowchart in FIG. 6 illustrates an example of the entire flow in the communication terminal 100. The flowchart in FIG. 7 illustrates a subroutine processing in step S610 of the flowchart in FIG. 6. First, the flowchart in FIG. 6 is described.

In step S601, the reception information determination unit 112 determines whether or not there is reception data. When the reception information determination unit 112 determines in step S601 that there is reception data (step S601: YES), the process proceeds to step S602. In contrast, when the reception information determination unit 112 determines in step S601 that there is no reception data (step S601: NO), the process proceeds to step S608.

In step S602, the reception information determination unit 112 determines whether or not terminal information has been received. Specifically, the reception information determination unit 112 determines whether or not the data determined to have been received in step S601 is terminal information. When the reception information determination unit 112 determines in step S602 that the data received is the terminal information (step S602: YES), the process proceeds to step S603. In contrast, when the reception information determination unit 112 determines in step S602 that the data received is not the terminal information (step S602: NO), the process proceeds to step S605.

In step S603, the terminal information acquisition unit 114 acquires the terminal information and updates connection information of each link stored in the terminal information DB 121 based on the acquired terminal information. Specifically, the terminal information acquisition unit 114 updates a value of a corresponding connection information column in the terminal information DB 121 in FIG. 5. Next, the process proceeds to step S604.

In step S604, the controller 110 updates the priority in the terminal information DB 121. Specifically, the controller 110 stores a value, indicating a priority as a connection destination having a high priority, for a connection destination having a high total value of connection strength. For example, in the example in FIG. 5, when the host terminal is the communication terminal T8, the route from the communication terminal T3 to the communication terminal T2 has the highest priority. In this case, the controller 110 of the communication terminal T8 determines that the priority of the communication to the communication terminal T3 is the highest, and sets “1” in the priority column of the route from the communication terminal T3 to the communication terminal T1 and the route from the communication terminal T3 to the communication terminal T2. Further, the controller 110 of the communication terminal T8 determines that the priority of the communication to the communication terminal T4 is the second, and sets “2” in the priority column of the route from the communication terminal T4 to the communication terminal T1 and the route from the communication terminal T4 to the communication terminal T2.

In step S605, the reception data processing unit 113 determines whether or not the reception data is data addressed to the host terminal. The reception data processing unit 113 determines whether or not the reception data is addressed to the host terminal based on information included in the header of the reception data.

In step S605, when the reception data processing unit 113 determines that the reception data is data addressed to the host terminal (step S605: YES), the process proceeds to step S606. In contrast, when the reception data processing unit 113 determines in step S605 that the reception data is not addressed to the host terminal (step S605: NO), the process proceeds to step S607.

In step S606, the reception data processing unit 113 stores the reception data addressed to the host terminal in the transmission/reception data DB 122. Then, the process ends. The communication terminal 100 performs predetermined processing on the reception data stored in step S606 in the transmission/reception data DB 122 according to the contents of the reception data.

In step S607, the reception data processing unit 113 generates data for transmission. Specifically, the reception data processing unit 113 stores the reception data as data for transmission in the transmission/reception data DB 122. Then, the process proceeds to step S609.

In step S608, the transmission timing determination unit 115 determines whether or not the timing for transmitting the predetermined terminal information has been reached. When the transmission timing determination unit 115 determines in step S608 that the timing for transmitting the predetermined terminal information has been reached (step S608: YES), the process proceeds to step S611. In contrast, when the transmission timing determination unit 115 determines in step S608 that the timing for transmitting the predetermined terminal information has not been reached (step S608: NO), the process proceeds to step S609.

In step S609, the data transmission determination unit 117 determines whether or not transmission data to be transmitted by the host terminal has been generated. The transmission data to be transmitted by the host terminal includes the data for transmission generated in the above-described step S607. The transmission data to be transmitted by the host terminal may include transmission data originating from the host terminal. The transmission data originating from the host terminal may include transmission data generated by the communication terminal 100 or transmission data stored in the transmission/reception data DB 122 via the input/output IF 140. When the data transmission determination unit 117 determines in step S609 that the transmission data to be transmitted by the host terminal has been generated (step S609: YES), the process proceeds to step S610. In contrast, when the data transmission determination unit 117 determines in step S609 that the transmission data to be transmitted by the host terminal has not been generated (step S609: NO), the process ends.

In step S610, subroutine processing related to the transmission processing of transmission data is performed. The subroutine processing related to the transmission processing of transmission data is described later with reference to the flowchart in FIG. 7.

In step S611, the terminal information transmission unit 116 transmits terminal information. Specifically, the terminal information transmission unit 116 transmits the connection information of each link stored in the terminal information DB 121 to other terminals connected to the host terminal at a predetermined timing. Then, the process ends.

Next, the subroutine processing of the data transmission processing in FIG. 7 is described.

In step S701, the data transmission determination unit 117 determines whether or not the terminal is a terminal of the highest layer. When the data transmission determination unit 117 determines in step S701 that the host terminal is the terminal of the highest layer (step S701: YES), the process proceeds to step S702. In contrast, when the data transmission determination unit 117 determines in step S701 that the host terminal is not the terminal of the highest layer (step S701: NO), the process proceeds to step S705.

In step S702, the data transmission determination unit 117 determines whether or not the destination terminal is in the second layer L2 that is the transmission destination. In the present embodiment, the destination terminal is a communication terminal 100 that is a final destination of transmission data in the network of the communication system 10.

That is, in step S702, the data transmission determination unit 117 determines whether or not the destination terminal is included in communication terminals 100 of the second layer L2 connected to the host terminal. When the data transmission determination unit 117 determines in step S702 that the destination terminal is in the second layer L2 that is the transmission destination (step S702: YES), the process proceeds to step S703. In contrast, when the data transmission determination unit 117 determines in step S702 that there is no destination terminal in the second layer L2 that is the transmission destination (step S702: NO), the process proceeds to step S704.

In step S703, the transmission unit 118 communicates with the destination terminal. Specifically, in step S703, the transmission unit 118 transmits the transmission data stored in the transmission/reception data DB 122 to the destination terminal. Then, the process returns to step S610 and ends.

In step S704, the transmission unit 118 communicates with terminals of a lower layer that is the transmission destination, in an area including the destination, in order of priority. Specifically, in step S704, the transmission unit 118 transmits the transmission data stored in the transmission/reception data DB 122 to a communication terminal 100 that is the transmission target according to the priority stored in the terminal information DB 121. For example, when the host terminal is the communication terminal T1, the communication terminal T1 transmits the transmission data to a communication terminal 100 having the highest priority of the communication terminal T3 or the communication terminal T4. After receiving an ACK or NACK response signal from the communication terminal T3 or the communication terminal T4, the communication terminal T1 transmits the transmission data to a communication terminal 100 having the second highest priority of the communication terminal T3 or the communication terminal T4. Then, the process returns to step S610 and ends.

In step S705, the data transmission determination unit 117 determines whether or not the destination of the data for transmission is a terminal in an area different from the host terminal. In step S705, when the data transmission determination unit 117 determines that the destination of the data for transmission is a terminal in an area different from the host terminal (step S705: YES), the process proceeds to step S706. In contrast, when the data transmission determination unit 117 determines in step S705 that the destination of the data for transmission is a terminal in the same area as the host terminal (step S705: NO), the process proceeds to step S709.

In step S706, the data transmission determination unit 117 determines whether or not the destination terminal is in an upper layer that is the transmission destination of the data for transmission. Specifically, in step S706, the data transmission determination unit 117 determines whether or not the destination terminal is included in communication terminals 100 of an upper layer that is the transmission destination. When the data transmission determination unit 117 determines in step S706 that the destination terminal is in the upper layer that is the transmission destination of the data for transmission (step S706: YES), the process proceeds to step S707. In contrast, when the data transmission determination unit 117 determines in step S706 that the destination terminal is not in the upper layer that is the transmission destination of the data for transmission (step S706: NO), the process proceeds to step S708.

In step S707, the transmission unit 118 communicates with the destination terminal. Specifically, in step S703, the transmission unit 118 transmits the transmission data stored in the transmission/reception data DB 122 to the destination terminal. Then, the process returns to step S610 and ends.

In step S708, the transmission unit 118 communicates with terminals of the upper layer that is the transmission destination in order of priority. Specifically, in step S708, the transmission unit 118 transmits the transmission data stored in the transmission/reception data DB 122 to a terminal that is the transmission target, according to the priority stored in the terminal information DB 121. Then, the process returns to step S610 and ends.

In step S709, the data transmission determination unit 117 determines whether the destination of the data for transmission is a terminal of the same layer. When the data transmission determination unit 117 determines in step S709 that the destination of the data for transmission is a terminal of the same layer (step S709: YES), the process proceeds to step S708. That is, when the destination of the data for transmission is in the same layer in the same area, the data for transmission is transmitted to the destination temporarily via a terminal of the upper layer. In contrast, when the data transmission determination unit 117 determines in step S709 that the destination of the data for transmission is not a terminal of the same layer (step S709: NO), the process proceeds to step S710.

In step S710, the data transmission determination unit 117 determines whether or not the destination of the data for transmission is a terminal of a lower layer. When the data transmission determination unit 117 determines in step S710 that the destination of the data for transmission is a terminal of the lower layer (step S710: YES), the process proceeds to step S711. In contrast, when the data transmission determination unit 117 determines in step S710 that the destination of the data for transmission is not a terminal of the lower layer (step S710: NO), the process proceeds to step S706.

In step S711, the data transmission determination unit 117 determines whether or not the destination terminal is in the lower layer that is the transmission destination of the data for transmission. Specifically, in step S711, the data transmission determination unit 117 determines whether the destination terminal is included in communication terminals 100 of the lower layer that is the transmission destination. When the data transmission determination unit 117 determines in step S711 that the destination terminal is in the lower layer that is the transmission destination of the data for transmission (step S711: YES), the process proceeds to step S712. In contrast, when the data transmission determination unit 117 determines in step S711 that the destination terminal is not in the lower layer that is the transmission destination of the data for transmission (step S711: NO), the process proceeds to step S713.

In step S712, the transmission unit 118 communicates with the destination terminal. Specifically, in step S703, the transmission unit 118 transmits the transmission data stored in the transmission/reception data DB 122 to the destination terminal. Then, the process returns to step S610 and ends.

In step S713, the transmission unit 118 communicates with terminals of the lower layer that is the transmission destination in order of priority. Specifically, in step 5713, the transmission unit 118 transmits the transmission data stored in the transmission/reception data DB 122 to the terminal that is the transmission target according to the priority stored in the terminal information DB 121. Then, the process returns to step S610 and ends.

As described above, the communication system 10 according to the present embodiment includes multiple communication terminals 100, and the multiple communication terminals 100 are layered in the first layer L1, the second layer L2, and the third layer L3. The communication system 10 includes at least two first communication terminals provided in the first layer L1. The communication system 10 includes multiple second communication terminals provided in the second layer L2 and capable of directly communicating with the first communication terminals. The communication system 10 includes multiple third communication terminals provided in the third layer L3 and capable of directly communicating with some of the second communication terminals. The second communication terminals and the third communication terminals are provided in multiple separate areas. Each of the third communication terminals performs communication via the first communication terminal when communicating with a second communication terminal or a third communication terminal in an area different from the area where the each of the third communication terminal is provided.

The configuration in which multiple communication terminals 100 are provided in the highest first layer L1 enables the communication system 10 to prevent a communication bottleneck in the highest layer. The communication terminals 100 included in the second layer L2 and the third layer L3 are provided in separate areas. Thus, for example, it is possible to prevent the concentration of communication to a specific communication terminal 100 of the second layer L2 or the third layer L3 and to prevent the increase of communication traffic.

Each of the communication terminals 100 provided in the communication system 10 includes the terminal information acquisition unit 114 that acquires terminal information including connection information on connections with communication terminals 100 included in the upper layer or the lower layer. The communication terminal 100 includes the data transmission determination unit 117 that determines a transmission destination of transmission data in a communication path to a destination terminal based on the terminal information. The communication terminal 100 includes the transmission unit 118 that transmits transmission data to another communication terminal 100 of the upper layer or the lower layer based on the determined result.

With this configuration, the communication terminal 100 determines the transmission destination of transmission data in a communication path to the destination terminal based on the terminal information including the connection information on the connection with the communication terminal 100 included in the upper layer or the lower layer. The communication terminal 100 transmits the transmission data to another communication terminal 100 of the upper layer or the lower layer based on the determined result. Thus, the communication terminal 100 in the communication system 10 determines a transmission destination based on the terminal information including the connection information and transmits transmission data, and thus it is possible to transmit data in an appropriate route based on the connection information.

In the present embodiment, the terminal information includes information on the communication strength in communication with other communication terminals 100. Thus, the priority order of transmitting data is determined based on the communication strength, and it is possible to perform the communication at an appropriate communication strength.

In the present embodiment, the terminal information may include connection information regarding communication between one communication terminal 100 of the upper layer or the lower layer and another communication terminal 100 connected to the one communication terminal 100 of the upper layer or the lower layer. Thus, for example, through determining a route and performing communication based only on necessary connection information rather than all the connection information in the communication system 10, it is possible to suppress communication of extra terminal information and to suppress an increase in communication traffic between communication terminals.

### Other Embodiments

Although the embodiment has been described in detail with reference to the drawings, the present embodiment is not limited by the contents described in the above embodiment. The constituent elements described above include those that may easily occur to a person skilled in the art and those that are substantially equivalent. The above-described configurations can be suitably combined. Various omissions, substitutions, or changes in configuration can be made without departing from the gist of the embodiments.

In the above-described embodiment, the terminal information is connection information relating to connection with other communicable communication terminals 100, and is the communication strength with other communicable communication terminals 100 as an example. The form in which the terminal information is the communication strength with other communication terminals 100 does not limit the configuration of the present embodiment. The terminal information may be, for example, information on throughput with other communication terminals 100. The terminal information may be, for example, SN ratio (signal-noise ratio) in communication with other communication terminals 100. For example, when the terminal information is the throughput, the communication terminal 100 can perform more appropriate communication in a system where communication of a large amount of data is necessary in communication with other communication terminals 100. When the terminal information is the SN ratio, the communication terminal 100 can perform more appropriate communication in a system where the quality of communication should be maintained in communication with other communication terminals 100.

A computer program (communication control program) causing a computer to execute the processing (communication control method) in the communication terminal 100 described above, and a computer-readable recording medium having the program recorded thereon are included in the scope of the present embodiment. The type of computer-readable recording medium is any type. The computer program is not limited to one recorded on the recording medium and may be one transmitted via a telecommunications line, a wireless or wired communication line, a network represented by the Internet, or the like.

The characteristics of the communication system 10 and the communication terminal 100 are described below.

The communication system 10 according to a first aspect includes multiple communication terminals 100 capable of communicating with each other and layered in a first layer, a second layer, and a third layer. The communication system 10 includes at least two first communication terminals that are communication terminals 100 provided in the first layer. The communication system 10 includes multiple second communication terminals that are communication terminals 100 provided in the second layer and capable of directly communicating with the first communication terminal. The communication system 10 includes multiple third communication terminals 100 that are provided the communication terminals provided in the third layer and are capable of directly communicable with some of the second communication terminals. The second communication terminals and the third communication terminals are provided in multiple separate areas. Each of the third communication terminals performs communication via one of the first communication terminals when communicating with one of the second communication terminals or the third communication terminals in an area different from an area where the each of the third communication terminal is provided.

In the above configuration, it is possible for the communication system 10 to prevent a communication bottleneck at the highest layer. The communication terminals 100 included in the second layer L2 and the third layer L3 are provided in separate areas. Thus, for example, it is possible to prevent the concentration of communication to a specific communication terminal 100 of the second layer L2 or the third layer L3 and to prevent an increase in communication traffic.

The communication terminal 100 according to a second aspect is the communication terminal 100 provided in the above-described communication system 10. The communication terminal 100 includes a terminal information acquisition unit 114 that acquires terminal information including connection information on a connection with a communication terminal 100 included in an upper layer or a lower layer. The communication terminal 100 includes a data transmission determination unit 117 that determines a transmission destination of transmission data in a communication path to a destination terminal, based on the terminal information. The communication terminal 100 includes a transmission unit 118 that transmits the transmission data to another communication terminal 100 of the upper layer or the lower layer based on a determined result.

In the above configuration, the communication terminal 100 determines a transmission destination of transmission data in a communication path to a destination terminal, based on the terminal information including connection information on a connection with a communication terminal 100 included in an upper layer or a lower layer. The communication terminal 100 transmits the transmission data to another communication terminal 100 of the upper layer or the lower layer based on a determined result. Thus, the communication terminal 100 in the communication system 10 determines a transmission destination based on the terminal information including the connection information and transmits the transmission data, and thus it is possible to transmit data through an appropriate route based on the connection information.

The terminal information of the communication terminal 100 according to a third aspect may include connection information regarding communication between one communication terminal 100 of the upper layer or the lower layer and another communication terminal 100 connected to the one communication terminal 100 of the upper layer or the lower layer.

In the above configuration, the communication terminal 100 determines a route and performs communication based on only on necessary connection information rather than all the connection information in the communication system 10, and thus it is possible to suppress communication of extra terminal information and to suppress an increase in communication traffic between communication terminals.

The terminal information of the communication terminal 100 according to a fourth aspect may include information on communication strength in communication with another communication terminal 100.

In the above configuration, the communication terminal 100 determines the priority order of transmitting data based on the communication strength, and it is possible to perform the communication at an appropriate communication strength.

The terminal information of the communication terminal 100 according to a fifth aspect may include information on throughput in communication with another communication terminal 100.

In the above configuration, it is possible for the communication terminal 100 to perform more appropriate communication in a system where communication of a large amount of data is necessary in communication with other communication terminals 100, for example.

The terminal information of the communication terminal 100 according to a sixth aspect may include information on an SN ratio in communication with another communication terminal 100.

In the above configuration, it is possible for the communication terminal 100 to perform more appropriate communication in a system where the quality of communication should be maintained in communication with other communication terminals 100.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication system including multiple communication terminals capable of communicating with each other and layered in a first layer, a second layer, and a third layer, the communication system comprising:
at least two first communication terminals that are communication terminals provided in the first layer;
multiple second communication terminals that are communication terminals provided in the second layer and are capable of directly communicating with the first communication terminals; and
multiple third communication terminals that are communication terminals provided in the third layer and are capable of directly communicating with some of the second communication terminals, wherein
the second communication terminals and the third communication terminals are provided in multiple separate areas, and
a third communication terminal from among the third communication terminals performs communication via one of the first communication terminals when communicating with one of the second communication terminals or one of the third communication terminals in an area different from an area where the third communication terminal is provided.

2. A communication terminal provided in the communication system according to claim 1, comprising:
a terminal information acquisition unit that acquires terminal information including connection information on a connection with a communication terminal included in an upper layer or a lower layer;
a data transmission determination unit that determines a transmission destination of transmission data in a communication path to a destination terminal, based on the terminal information; and
a transmission unit that transmits the transmission data to another communication terminal of the upper layer or the lower layer based on a determined result.

3. The communication terminal according to claim 2, wherein
the terminal information includes the connection information regarding communication between one communication terminal of the upper layer or the lower layer and another communication terminal connected to the one communication terminal of the upper layer or the lower layer.

4. The communication terminal according to claim 2, wherein
the terminal information includes information on communication strength in communication with another communication terminal.

5. The communication terminal according to claim 2, wherein
the terminal information includes information on a throughput in communication with another communication terminal.

6. The communication terminal according to claim 2, wherein
the terminal information includes information on an SN ratio in communication with another communication terminal.
